(19) United States
(12) Patent Application Publication
(10) Pub. No.: US 2010/0088113 A1
(43) Pub. Date: Apr. 8, 2010

(54) MEDICAL INFORMATION CONTROLLER AND MEDICAL IMAGE SYSTEM

(76) Inventor: Hiroyuki Kubota, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/596,116

(22) PCT Filed: Apr. 2, 2008
(86) PCT No.: PCT/JP2008/056553

§ 371 Date: Oct. 15, 2009

(30) Foreign Application Priority Data
Apr. 19, 2007 (JP) 2007-110645

(51) Int. Cl. G06Q 50/00

(52) U.S. Cl. 705/2; 382/128

(57) ABSTRACT

A medical information controller and a medical image system which make it possible to refer an image as desired from an electronic medical chart terminal (40) according to need. The electronic medical chart terminal (40) transmits request information containing an image specifying condition and an image processing condition to the medical information controller (50) through the Web. The medical information controller (50) transmits only information on the image specifying condition out of the request information to an image server (10), and receives a DICOM image from the image server (10). The electronic medical chart terminal (40) receives the processed image by the medical information controller (50) and displays it.

### TECHNICAL FIELD

The present invention relates to a medical information controller and a medical image system.

### BACKGROUND ART

In recent years, computerization of medical information is in progress in many medical institutions. A medical image system is one of the examples of the computerization. Roughly dividing, the medical image system is constituted with electronic medical chart terminals and an image server which is connected to the electronic medical chart terminals via communication circuits. The electronic medical chart terminal includes an entering/operating function to be operated by the medical chart creator (mainly, a referring doctor) him/herself and a display function of data/image and the like. Further, the image server stores and manages medical images, image reading reports and the like obtained at the radiology department or the like in a form of electronic data.

According to such medical image system, the medical chart creator can obtain the medical images, the image reading reports and the like which are stored in the image server at the electronic medical chart terminal and can referred to them directly.

Because the electronic medical chart terminal is provided to be used for creating an electronic medical chart, viewing a medical examination result and the like, the electronic medical chart terminal mainly handles text information. Therefore, the electronic medical chart terminal usually is not provided with an advanced image processing function and the like as in a diagnostic reading terminal used by a diagnostic reading doctor, and there is no need to be provided with an advanced function in view of cost-benefic performance. Thus, it is sufficient that the medical image provided to the electronic medical chart terminal is for a simple reference, and further, it is sufficient that the medical image (hereinafter, called “processed image”) which is converted into a data of JPEG, PDF and the like, compressed and processed is provided by an all-purpose communication standard such as HTTP.

Such medical image system is disclosed as a web-compliant electronic medical chart system to be used in a broad area in Patent Document 1, for example.

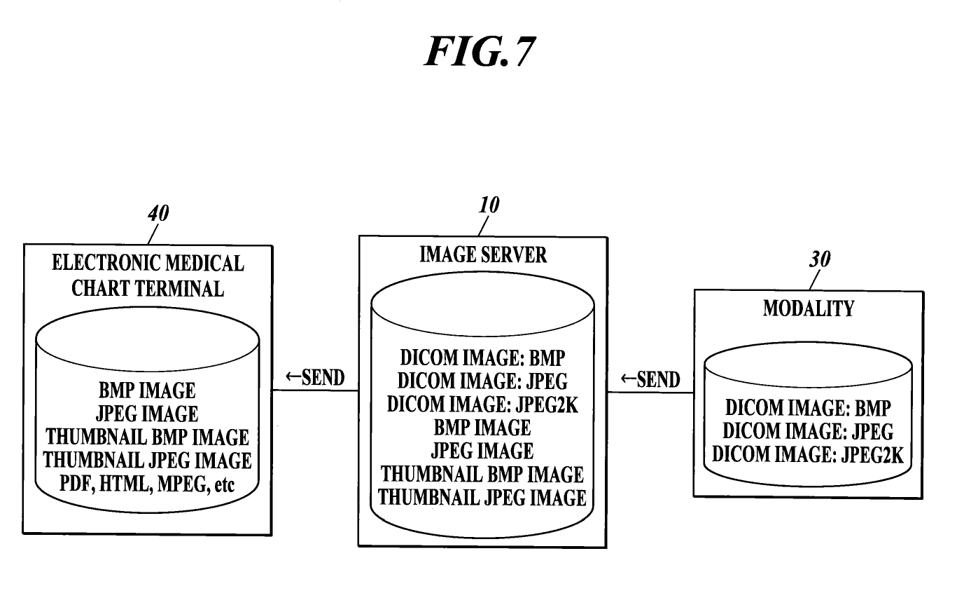

Here, the data format which is handled by the web-compliant medical image system will be described with reference to FIG. 7. First, a modality 30 generates a medical image of DICOM standard (hereinafter, called DICOM image), then, the medical image is transmitted to the image server 10 as needed. Then, the image server 10 stores the DICOM image. As shown in FIG. 7, image data of the medical image which is transmitted and received between the modality 30 and the image server 10 may be different being a bitmap image, a JPEG image or the like. However, there is no difference in that the image data of the medical image is a DICOM image in which accompanying information of DICOM standard is attached to the image data.

On the other hand, a processed image in which the accompanying information is removed from the DICOM image and in which compression and the like is carried out is handled between the imager server 10 and the electronic medical chart terminal 40. Here, the image server 10 is to create a processed image in advance and is to store the processed image so that the image server 10 can respond to a request instruction from the electronic medical chart terminal 40 requesting for the processed image. In such way, a referring doctor can view the processed image for a simple reference at the electronic medical chart terminal 40 via the web-compliant all-purpose communication.

### Patent Document 1: JP10-79770 A

### DISCLOSURE OF THE INVENTION

### Problem to be Solved by the Invention

In the electronic medical chart system as described in the Patent Document 1, the processed image which can be received at the electronic medical chart terminal 40 is an image in which a predetermined image processing is carried out to the DICOM image and which is compressed, which is a ready-made medical image. Therefore, when a referring doctor tries to carry out a further image processing to the processed image in order to make the processed image be more suited for referring by using commercially available image processing software and the like, the processed image will become even more unsuitable for viewing. Further, when the processed image is, for example, PDF, even a simple image processing cannot be carried out. Furthermore, as described above, unlike DICOM image, attached information is removed from the processed image. Therefore, the referring doctor cannot recognize the patent information, the examination information and the like, for example, from the processed image.

Moreover, as shown in FIG. 7, the image server 10 needs to store the processed images which are for the electronic medical chart terminals 40 in advance. However, in the electronic medical chart terminals 40, text information is mainly handled and medical images are used as incidental material. Therefore, there is a case where the large amount of processed images which are stored in the image server 10 in advance are needed, however, there is a case where the processed images are not referred to and are unnecessarily stored. Thus, it cannot be said that the storage capacity of the image server 10 is effectively used.

An object of the present invention is to provide a medical information controller and a medical image system in which a medical image in which a desired image processing is carried out can be referred to as needed at an electronic medical chart terminal.

### Means for Solving the Problem

According to the invention described in claim 1, there is provided a medical information controller which is provided between an electronic medical chart terminal to generate an electronic medical chart and an image server to store a medical image comprising a first communication unit to carry out a communication with the electronic medical chart terminal, a second communication unit to carry out a communication with the image server, an information control unit to convert information of an image specifying condition to information according to an image management standard of the image server and to transmit the converted information to the image server when request information is received from the electronic medical chart terminal, the request information including the image specifying condition to instruct a specifying of a medical image and an image processing condition to instruct an image processing of the specified medical image and an image processing control unit to receive the medical image which is specified by the image specifying condition from the image server, to generate a processed image by carrying out the image processing based on the image processing condition to the received medical image and to transmit the processed image to the electronic medical chart terminal.

According to the invention described in claim 2, there is provided the medical information controller of claim 1, wherein the image management standard is a DICOM standard and the information control unit converts the information of the image specifying condition to information according to the DICOM standard and transmits the converted information to the imager server.

According to the invention described in claim 3, wherein provided the medical information controller of claim 1 or 2, wherein the first communication unit carries out the communication with the electronic medical chart terminal by a web compliant communication protocol and the second communication unit carries out the communication with the image server by a DICOM compliant communication protocol.

According to the invention described in claim 4, there is provided a medical image system comprising an electronic medical chart terminal to generate an electronic medical chart, an image server to store a medical image and a medical information controller to control medical information which is transmitted and received between the electronic medical chart terminal and the imager server, wherein the electronic medical chart terminal comprises a communication unit to carryout a communication with the medical information controller and a control unit to generate request information including an image specifying condition to specify a medical image which is a target for an image processing and an image processing condition to indicate an image processing content which is to be carried out to the specified medical image, and to transmit the request information to the medical information controller via the communication unit, and the medical information controller comprises a first communication unit to carry out a communication with the electronic medical chart terminal, a second communication unit to carry out a communication with the imager server, an information control unit to convert information of the image specifying condition into information according to an image management standard of the image server and to transmit the converted information to the image server when the request information including the image specifying condition to instruct the specifying of the medical image and the image processing condition to instruct the image processing of the specified medical image is received from the electronic medical chart terminal and an image processing control unit to receive the medical image which is specified by the image specifying condition from the image server, to generate a processed image by carrying out the image processing based on the image processing condition to the received medical image and to transmit the processed image to the electronic medical chart terminal.

### ADVANTAGEOUS EFFECT OF THE INVENTION

According to the present invention, when the request information including the image specifying condition and the image processing condition is transmitted to the image server at the electronic medical chart terminal via the medical information controller, the image processing according to the request can be carried out.

Thereby, the processed image according to a request from a referring doctor can be displayed without the electronic medical chart terminal being provided with advanced image processing function and the like. On the other hand, there is no need for the image server to generate unnecessary processed images in advance and to store the processed image for long period of time. Therefore, the storage capacity can be used effectively. Further, when each of the electronic medical chart terminals and the image server is to carry out communication between one another, transmitting and receiving of the request information and transmitting and receiving of the processed image can be carried out without carrying out a treatment so as to make the electronic medical chart terminals and the image server be compliant to the communication standard. Therefore, the system can be structured at a low cost.

Moreover, the actual generating of the processed image by carrying out the image processing is carried out by the medical information controller and not by the electronic medical chart terminals or the image server. Therefore, the processing can be executed effectively without causing burden on the above two devices due to a processing according to the generation of the processed image.

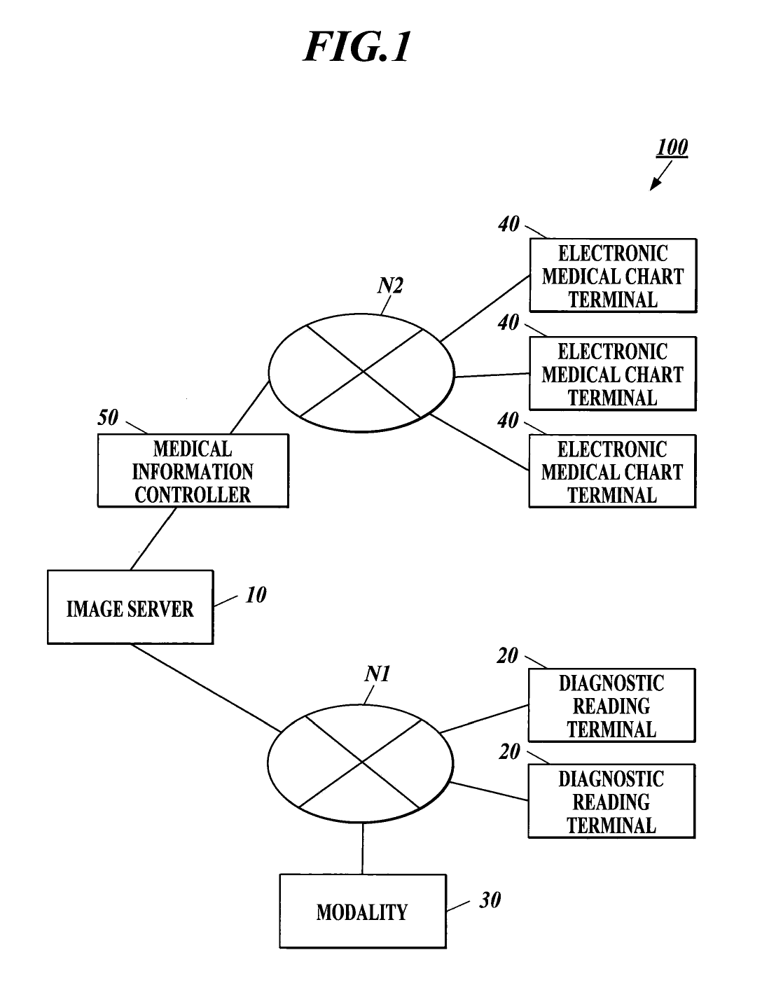

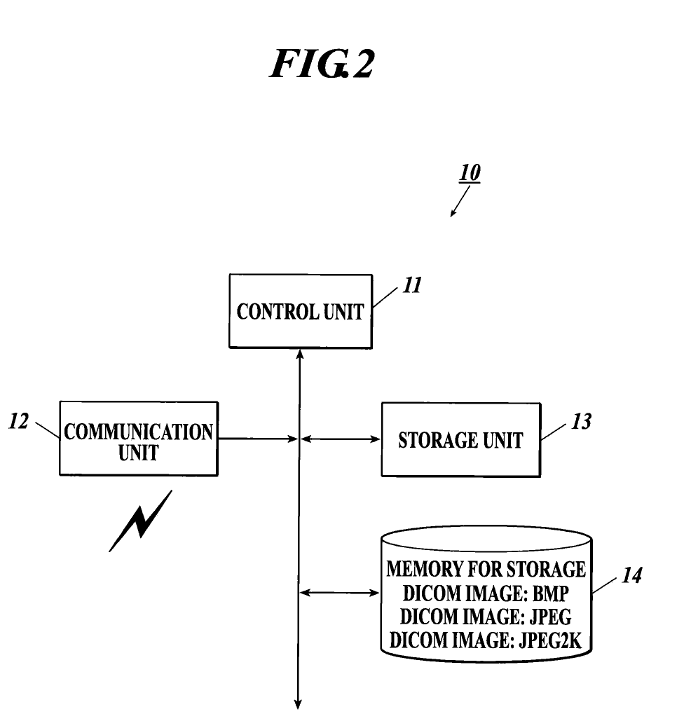

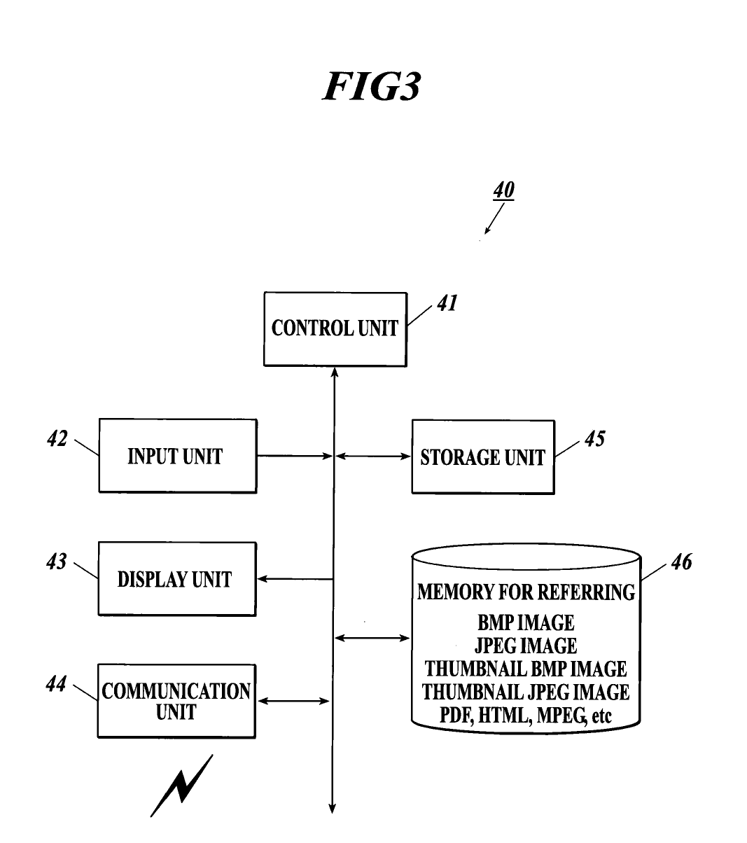

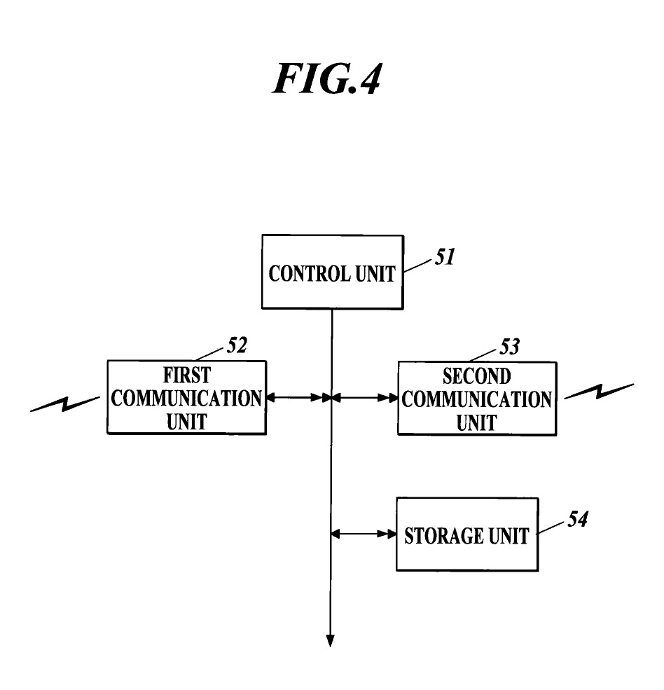

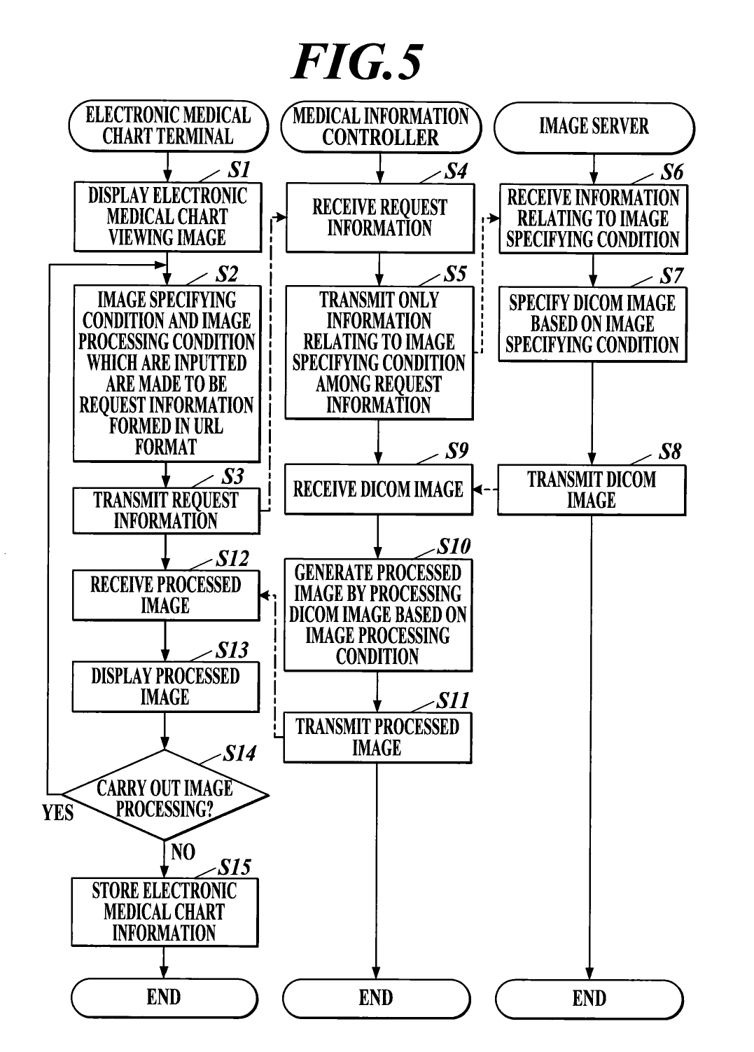

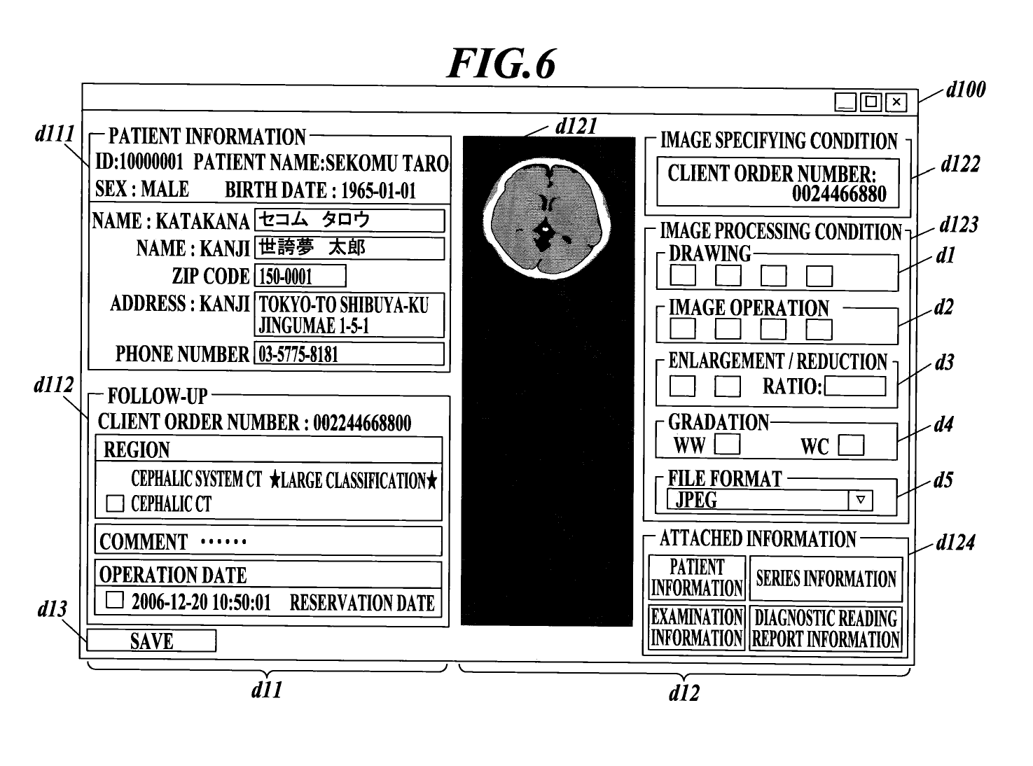

### BRIEF DESCRIPTION OF THE DRAWINGS

[FIG. 1] This is a diagram showing an entire structure of an electronic medical chart system of the embodiment.

[FIG. 2] This is a diagram showing an inner structure of an image server of FIG. 1.

[FIG. 3] This is a diagram showing a structure of an electronic medical chart terminal of FIG. 1.

[FIG. 4] This is a diagram showing a structure of a medical information controller of FIG. 1.

[FIG. 5] This is a flowchart for explaining a flow of a process of a medical image system.

[FIG. 6] This is a diagram showing an example of a viewing screen of an electronic medical chart.

[FIG. 7] This is a diagram for explaining data format to be handled in a conventional medical image system.

### EXPLANATION OF REFERENCE NUMERALS

1 Electronic medical chart system
10 Image server
11 Control unit
14 Memory for storage
20 Diagnostic reading terminal
30 Modality
40 Electronic medical chart terminal
41 Control unit
42 Input unit
43 Display unit
46 Memory for referring
50 Medical information controller
51 Control unit

### BEST MODE FOR CARRYING OUT THE INVENTION

Hereinafter, a structure and an operation of a best mode of an electronic medical chart terminal, an image server and an electronic medical chart system according to the present invention will be described with reference to the drawings.

First, a medical image system 1 of the embodiment is shown in FIG. 1.

The medical image system 1 includes the first system in which an image server 10 and a diagnostic reading terminals 20 and a modality 30 are connected via a network N1 and the second system in which the image server 10, electronic medical chart terminals 40 and a medical information controller 50 are connected via the network N2. The first system is used by a diagnostic reading doctor who mainly performs a diagnostic reading of a medical image, and the second system is used by a referring doctor who performs medical examination by using the result of the diagnostic reading.

First, the first system will be described.

The image server 10 generates DICOM image from an imaged image which is generated by imaging in the modality 30, and the image server 10 stores and manages the DICOM image. Further, the image server 10 also stores the diagnostic reading report which is generated at the diagnostic reading terminal 20.

A structure of the image server 10 is shown in FIG. 2.

As shown in FIG. 2, the image server 10 comprises a control unit 11, a communication unit 12, a storage unit 13, a memory for storage 14.

The control unit 11 carries out an integrated control of each parts and various types of calculations by cooperating with the control program which is stored in the storage unit 13.

The control unit 11 carries out a unify management of the medical images by using the order information transmitted from the electronic medical chart terminal 40. The order information is a request information relating to a series of processes and operations from imaging to generation and to diagnostic reading of the medical image, and for example, the order information includes request information which assigns a patient whose medical image is to be imaged, a doctor who performs diagnostic reading of the medical image and the like.

The communication unit 12 comprises an interface for communication, and carries out communication with each of the devices on the networks N1 and N2. Here, a communication protocol of DICOM is used when delivering a medical image to the diagnostic reading terminal 20, and a protocol for an all-purpose web communication such as HTTP and the like is used when delivering a medical image and the like to the electronic medical chart terminal 40. Therefore, the electronic medical chart terminals 40 of the embodiment do not need to be a DICOM compliant terminal and a general PC (Personal Computer) and the like can be applied. Therefore, a cost can be reduced.

The storage unit 13 stores a control program and a parameter, files and the like which are needed for executing the control program.

The memory for storage 14 is constituted with a large capacity memory and stores diagnostic reading reports other than the medical images.

The diagnostic reading terminal 20 displays the medical image to be used for diagnostic reading by a diagnostic reading doctor, and the diagnostic reading terminal 20 is provided with an advanced image processing function and displays the medical image in high resolution. As for the diagnostic reading terminal 20, a PC in which a software for viewing medical images is installed or the like is suggested. That is, the diagnostic reading terminal 20 comprises a control unit, an operation unit, a display unit, a communication unit a storage unit and the like.

Further, the diagnostic reading terminal 20 includes a diagnostic reading report generation function. At the time of diagnostic reading, not only the medical image obtained from the image server 10 is displayed, but also, a generation screen for a diagnostic reading report is displayed and information inputted in the generation screen becomes the diagnostic reading report.

The modality 30 generates an imaged image by an examination imaging. As for the modality 30, a CR (Computed Radiography) device, a MRI (Magnetic Resonance Imaging) device, a CT (Computed Tomography) device and the like is suggested, for example.

Next, the second system will be described.

In the second system, the medical images and the diagnostic reading reports which are stored in the imager server 10 are provided to the electronic medical chart terminals 40. Further, the medical information controller 50 provides the processed images to the electronic medical chart terminals 40.

The electronic medical chart terminal 40 includes an electronic medical chart function to generated electronic medical charts, and also, the electronic medical chart terminal 40 displays the medical image and the diagnostic reading report to be used for the medical examination by a referring doctor. Further, at the electronic medical chart terminal 40, the order information relating to the medical image is generated, and imaging condition, diagnostic reading condition and the like for the medical image can be assigned by transmitting the generated order information to the imager server 10.

A structure of the electronic medical chart terminal 40 is shown in FIG. 3.

As shown in FIG. 3, the electronic medical chart terminal 40 comprises a control unit 41, an input unit 42, a display unit 43, a communication unit 44, a storage unit 45 and a memory for referring 46.

The control unit 41 comprises a CPU, a RAM and the like and carries out an integrated control of each parts and various types of calculations by cooperating with programs such as a control program for electronic medical chart generation which are stored in the storage unit 45. For example, the control unit 41 carries out a generation process of an electronic medical chart by cooperating with the electronic medical chart program. Further, the control unit 41 carries out various types of image processing to the medical image by cooperating with the image processing program.

The input unit 42 comprises a mouse, a key board and the like, and the input unit 42 generates an input signal according to an input operation of the mouse, the key board and the like and outputs the generated input signal to the control unit 41.

The display unit 43 comprises a display and displays various types of operation screens such as a display screen of a medical image, a generation screen of an electronic medical chart and the like on the display according to the control of the control unit 41.

The communication unit 44 comprises an interface for communication and carries out a communication with the image server 10 and the like on the network N1.

The storage unit 45 stores the control program, a parameter, files and the like which are needed for executing the control program.

The memory for referring 46 is a memory for storing the medical image and the diagnostic reading report which are obtained for referring, the electronic medical chart which is generated and the like. Here, this information may be stored in the memory for storage 14 of the image server 10.

The medical information controller 50 includes a function to transmit only the information relating to image specifying condition to the image server 10 among the request information to be transmitted to the image server 10 from the electronic medical chart terminal 40. Further, the medical information controller 50 generates a processed image by carrying out image processing based on the image processing condition when the medical information controller 50 receives the DICOM image from the image server 10, and transmits the generated processed image to the electronic medical chart terminal 40.

The medical information controller 50 carries out transmitting and receiving of information between the electronic medical chart terminal 40 by using a web compliant communication standards, and carries out transmitting and receiving of information between the image server 10 by using DICOM compliant communication standards. Thereby, the electronic medical chart terminal 40 does not have to use the DICOM compliant communication standards and the image server 10 does not have to use the web compliant communication standards in order to carry out the transmitting and receiving of information.

A structure of the medical information controller 50 is shown in FIG. 4.

As shown in FIG. 4, the medical information controller 50 comprises a control unit 51, a storage unit 52, the first communication unit 53 and the second communication unit 54.

The control unit 51 comprises a CPU, a RAM and the like, and carries out an integrated control of each of the processes by cooperating with a control program of the request information which is stored in the storage unit 52. For example, the control unit 51 transmits information relating to the image specifying condition among the request information to the image server 10, and also carries out the image processing to the DICOM image based on the image processing condition so that the DICOM image becomes the processed image.

The storage unit 52 stores the above described control program and a parameter, files and the like which are needed for executing the control program.

The first communication unit 53 and the second communication unit 54 comprise an interface for communication. Here, the first communication unit 53 carries out a communication with the electronic medical chart terminal 40 and uses a web compliant communication protocol. On the other hand, the second communication unit 54 carries out a communication with the image server 10 and uses a DICOM compliant communication protocol.

Next, an operation of the medical information controller 50, the electronic medical chart terminal 40 and the image server 10 according to the embodiment will be described.

FIG. 5 is a flowchart for explaining a flow of the process which is carried out between the electronic medical chart terminal 40 and the image server 10 via the medical information controller 50.

First, at the electronic medical chart terminal 40, the control unit 41 activates the electronic medical chart program and makes the generation screen of electronic medical chart be displayed on the display unit 43. Then, when a patient who is the target for viewing of the medical chart is selected by an operator in the generation screen, the control unit 41 makes the electronic medical chart viewing screen of the patient be displayed (step S1).

An example of the electronic medical chart viewing screen is shown in FIG. 6.

As shown in FIG. 6, the electronic medical chart viewing screen d100 comprises a medical chart information unit d11 and an image information unit d12. Further, a save button d13 for storing all of the information which are displayed in the viewing screen is displayed.

The medical chart information unit d11 is used for displaying the medical chart information and comprises a patient information unit d111 and a follow-up unit d112. At the patient information unit dill, insurance card information, patient information (for example, patent name, patient ID) and the like are displayed. Further, at the follow-up unit d112, past examination results, future treatment plan and the like of the patient are displayed.

The image information unit d12 comprises an image display unit d121, an image specifying condition input tool d122, an image processing condition input tool d123 and an accompanying information display unit d124.

At the image display unit d121, a medical image of a patient who is the target for viewing medical chart is displayed.

At the image specifying condition input tool d122, an input space for inputting the image specifying condition is displayed. The image specifying condition may be a patient name, a patient ID, an order number, an examination instance UID and the like, for example, which are unique information that can specify the medical image. A processed image is displayed in the image display unit d121 based on the inputted image specifying condition.

At the image processing condition input tool d123, an input space or a selection space for further inputting and specifying the image processing condition regarding the processed image which is to be displayed is displayed. The image processing condition may be changing of gradation process, file format and the like, for example, which is information for generating a processed image by carrying out the changing process, the compression process and the like to the DICOM image.

At the accompanying information display unit d124, content of the accompanying information of the DICOM image is displayed. As for the accompanying information of the DICOM image, there are patient information including name and the like of the patient, examination information including the date of examination and the like and diagnostic reading report information including name of the diagnostic reading doctor, the date of generation and the like.

Here, in the embodiment, as shown in FIG. 6, a predetermined processed image and accompanying information of the processed image are displayed in the image display unit d121 and the accompanying information display unit d124 in advance. However, the image display unit d121 and the accompanying information display unit d124 may be blank until the medical information controller 50 transmits the processed image to the electronic medical chart terminal 40 (see step S11 of FIG. 5).

Here, the above described image processing condition input tool d123 will be further described.

A drawing tool d1 for giving instruction to combine lines and letters, an image tool d2 for carrying out operation of processed image, an enlargement/reduction tool d3, a gradation tool d4 for carrying out gradation changing processing, a file format selection tool d5 for carrying out specification of file format and the like are included in the image processing condition input tool d123. By an operator operating each of the tools, the control unit 41 carries out an overlay display of the patient ID, the examination date, the diagnostic reading report and the like on the processed image, also rotates the processed image, makes the processed image be in 3D and makes the processed image be a video image. Further, the control unit 41 can specify the image processing condition in the actual size by numerical measurement.

By the functions of each of the parts in the electronic medical chart viewing screen d100, an operator can view the information regarding the patient which is displayed in the medical chart information unit d11 and also can view a medical image of the patient by displaying the medical image in the image information unit d12. Further, an operator can input an instruction so as to carryout an arbitrary image processing regarding the displayed medical image.

Here, the image processing which is carried out by carrying out an input-operation of the image processing condition input tool d123 only inputs condition for the image processing and the control unit 41 is not actually carrying out the image processing by the image processing software and the like. The image to be displayed in the image display unit d121 is a processed image in which the compression process and the like are carried out to the DICOM image. Therefore, in a case where an enlargement process is simply carried out to the processed image by the image processing software or the like for instance, indentations called jaggy appears in the outline of the image, and further, the information is deleted when the reduction process is carried out to the processed image. In such way, the processed image is not suitable for the image processing such as enlargement, reduction and modifying.

Consequently, in the embodiment, the image processing is not actually carried out to the processed image and only the condition for the image processing is input-operated. The medical information controller 50 which received the instruction of image processing and the like from the electronic medical chart terminal 40 is to actually carry out the image processing.

When the image specifying condition and the image processing condition are inputted by an operator, the control unit 41 makes the inputted image specifying condition and image processing condition be the request information structured which is in a URL format such as “http://host name/service name+image specifying condition+image processing condition” or the like, for example (step S2). Here, when an imager server name is inputted for the host name and the obtaining request of medical image is inputted for the service name, the structure will be such as “http://i-pacs1/images?patientdid=003 . . . ”.

By structuring such request information, the electronic medical chart terminal 40 can carry out transmitting and receiving of the processed image by an all-purpose communication system such as HTTP which is a web compliant communication protocol, for example, and not being limited to the communication by DICOM.

The control unit 41 transmits the request information to the medical information controller 50 (step S3).

The medical information controller 50 receives the request information which is transmitted from the electronic medical chart terminal 40 (step S4). The control unit 51 transmits the information relating to the image specifying condition among the received request information to the image server 10, and temporarily stores the information relating to the image processing condition (step S5). Here, the information relating to the image specifying condition which is to be transmitted to the image server 10 by the medical information controller 50 is transmitted by being converted into DICOM compliant information by the medical information controller 50.

The conversion to DICOM compliant information is carried out by the control unit 51 transcribing the arguments expressing the patient ID and the order number in the request information to the DICOM standard. Particularly, when a medical image which is specified by the argument of “003” of patient ID and the argument “090” of the order information ID is to be obtained from the image server 10, the request information from the electronic medical chart terminal 40 will be in a structure such as “http://i-pacs1/images?patientid=003&orderno=090”. The control unit 51 which received the request information converts the image specifying condition to the information expressing the image specifying condition of DICOM standard by the argument “003” of the patient ID and the argument “090” of the order information ID. Further, the control unit 51 transmits the converted information of image specifying condition to the image server 10.

In such way, the image server 10 can receive information from the electronic medical chart terminal 40 by the DICOM compliant communication protocol which is originally provided at the image server 10.

The image server 10 receives the information relating to the image specifying condition which is transmitted from the medical information controller 50 (step S6). The control unit 11 specifies the DICOM image which is in the memory for storage 14 based on a search service (DICOM) which uses the received information relating to the image specifying condition in the image server 10 (step S7). Here, the search service is not limited to DICOM, and any service which can specify the DICOM image within the image server 10 can be applied.

Further, in order for the control unit 11 to individually specify the DICOM images, as a premise, the SOP instance UID is to be included in the accompanying information of the DICOM images which are stored in the memory for storage 14. The SOP instance UID is a unique value which can specify the location of the DICOM image in the memory for storage 14. The control unit 11 specifies the DICOM image by the SOP instance UID.

The control unit 11 transmits the specified DICOM image to the medical information controller 50 (step S8). Here, the DICOM image to be transmitted is a replicate of the DICOM image in the image server 10.

The medical information controller 50 receives the DICOM image which is transmitted from the image server 10 (step S9). Then, regarding the received DICOM image, the control unit 51 generates a processed image based on the image processing condition (step S10). Differently from the DICOM image, data amount of the processed image is small because of deterioration, compression and the like. Therefore, the processed image is suitable for a simple viewing of medical image. Further, by converting the accompanying information of the DICOM image to an all-purpose text information (for example, HTML or the like) and by making the converted information be accompanying the image data of the processed image, the referring doctor can recognize the information (f roe example, patient information, examination information and the like) about the image data of the processed image similarly to the DICOM image.

In such way, by processing the DICOM image, the electronic medical chart terminal 40 can receive and display the processed image without being provided with a special function which is compliant to DICOM. Further, the information relating to the processed image such as patient information, examination information, diagnostic reading report and the like, for example, can be displayed in a predetermined display space (see FIG. 6).

The control unit 51 transmits the processed image to the electronic medical chart terminal 40 (step S11).

The electronic medical chart terminal 40 receives the processed image which is transmitted from the medical information controller 50 (step S12). Then, the control unit 41 makes the received processed image be displayed in the image display unit d121 (step S13). Here, the accompanying information is made to be displayed in the accompanying information display unit d124. The operator can carry out a medical examination by viewing the electronic medical chart along with the displayed processed image.

When further carrying out image processing to the processed image which is being displayed, the control unit 41 is to transmit new request information to the medical information controller 50 similarly to the process of step S2 and thereafter (step 514; Yes).

When ending the viewing by storing the displayed processed image and the accompanying information along with the information of the electronic medical chart (step S14; No), the save button d13 is pressed by an operator, and the control unit 41 stores the information of the electronic medical chart (including the processed image) in the memory for referring 46 according to the operation of an operator (step S15) and the process is finished.

As described above, according to the embodiment, the image specifying condition and the image processing condition can be input-operated at the electronic medical chart terminal 40. Further, the electronic medical chart terminal 40 transmits the request information which is generated by an input-operation of an operator to the medical information controller 50.

The medical information controller 50 which received the request information can transmit only the information relating to the image specifying condition among the request information to the image server 10. Further, at the time of transmission, the information relating to the image specifying condition is converted to the DICOM standard which is the image management standard of the image server 10. Then, the medical information controller 50 can receive the DICOM image which is specified by the image server 10, and can generate a processed image based on the image processing condition and can transmit the generated processed image to the electronic medical chart terminal 40.

The electronic medical chart terminal 40 can receive and display the processed image which is generated by the medical information controller 50. Further, the electronic medical chart terminal 40 can further carry out image processing to the displayed processed image.

In such way, by carrying out the transmitting and receiving of information between the electronic medical chart terminal 40 and the imager server 10 via the above described medical information controller 50, the electronic medical chart terminal 40 and the image server 10 can execute a predetermined process without respectively being provided with a function which is compliant to new communication standard (as for the electronic medical chart terminal 40, a function compliant to DICOM, and as for the image server 10, a function compliant to web). Thus, the electronic medical chart terminal 40 and the image server 10 having conventional structure can be used as they are, and the medical image system 1 can be structured without using a cost for trading the existing devices to new devices.

Further, each of the devices divides the process such that the electronic medical chart terminal 40 carries out generation and transmission of the request information, the image server 10 carries out specification and transmission of the DICOM image and the medical information controller 50 carries out control of the above information and image processing. Therefore, processing efficiency of the medical image system 1 as a whole can be improved.

### INDUSTRIAL APPLICABILITY

The medical information controller and the medical image system can be used in the medical field, and can be applied to an image processing device for carrying out image processing to a medical image.

1. A medical information controller which is provided between an electronic medical chart terminal to generate an electronic medical chart and an image server to store a medical image, comprising:
a first communication unit to carry out a communication with the electronic medical chart terminal;
a second communication unit to carry out a communication with the image server;
an information control unit to convert information of an image specifying condition to information according to an image management standard of the image server and to transmit the converted information to the image server when request information is received from the electronic medical chart terminal, the request information including the image specifying condition to instruct a specifying of a medical image and an image processing condition to instruct an image processing of the specified medical image; and
an image processing control unit to receive the medical image which is specified by the image specifying condition from the image server, to generate a processed image by carrying out the image processing based on the image processing condition to the received medical image and to transmit the processed image to the electronic medical chart terminal.

2. The medical information controller of claim 1, wherein
the image management standard is a DICOM standard, and
the information control unit converts the information of the image specifying condition to information according to the DICOM standard and transmits the converted information to the imager server.

3. The medical information controller of claim 1 or 2, wherein
the first communication unit carries out the communication with the electronic medical chart terminal by a web compliant communication protocol, and
the second communication unit carries out the communication with the image server by a DICOM compliant communication protocol.

4. A medical image system, comprising:
an electronic medical chart terminal to generate an electronic medical chart;
an image server to store a medical image; and
a medical information controller to control medical information which is transmitted and received between the electronic medical chart terminal and the imager server, wherein
the electronic medical chart terminal comprises
a communication unit to carry out a communication with the medical information controller, and
a control unit to generate request information including an image specifying condition to specify a medical image which is a target for an image processing and an image processing condition to indicate an image processing content which is to be carried out to the specified medical image, and to transmit the request information to the medical information controller via the communication unit,
the medical information controller comprises
a first communication unit to carry out a communication with the electronic medical chart terminal,
a second communication unit to carry out a communication with the imager server,
an information control unit to convert information of the image specifying condition into information according to an image management standard of the image server and to transmit the converted information to the image server when the request information including the image specifying condition to instruct the specifying of the medical image and the image processing condition to instruct the image processing of the specified medical image is received from the electronic medical chart terminal; and
an image processing control unit to receive the medical image which is specified by the image specifying condition from the image server, to generate a processed image by carrying out the image processing based on the image processing condition to the received medical image and to transmit the processed image to the electronic medical chart terminal.
